(19) United States
(12) Patent Application Publication
(10) Pub. No.: US 2025/0385809 A1
(43) Pub. Date: Dec. 18, 2025

(54) REINFORCEMENT LEARNING FOR SWITCH POWER OPTIMIZATION

(71) Applicant: NVIDIA Corporation, Santa Clara, CA (US)

(72) Inventors: Gal Dalal, Shimshit (IL); Amit Kazimirsky, Givat Shmuel (IL); Jonathan Paul, Tel Aviv (IL)

(21) Appl. No.: 18/741,609

(22) Filed: Jun. 12, 2024

(51) Int. Cl. H04L 12/40; G06F 1/3209; H04L 12/12

(52) U.S. Cl. CPC H04L 12/40039; G06F 1/3209; H04L 12/12

(57) ABSTRACT

Network switches are devices that connect multiple devices together on a computer network, using packet switching to receive, process, and forward data to the destination device. Each switch typically contains multiple ports, which are the points of connection for network cables. These ports can be in an active state, where they are ready to transmit data, or in an idle state, where they consume less power. Power consumption in datacenters has been a topic of concern due to the increasing demand for data processing and storage. One approach to reducing power consumption involves managing the power state of the switch ports. However, current power saving policies focus on making decisions for one type of traffic pattern or for a single port at a time, and therefore cannot intelligently or dynamically adapt to a multitude of network parameters affecting traffic flows. The present disclosure uses artificial intelligence to more intelligently transition ports between different modes of operation.

### TECHNICAL FIELD

The present disclosure relates to management of switch operations.

### BACKGROUND

Datacenters are complex systems that house a multitude of servers, storage devices, and network equipment. These facilities are responsible for processing, storing, and transmitting vast amounts of data, making them integral to the functioning of many businesses and organizations. However, the operation of these datacenters requires a substantial amount of power, particularly for the network switches that facilitate data transmission across the network fabric.

Network switches are devices that connect multiple devices together on a computer network, using packet switching to receive, process, and forward data to the destination device. Each switch typically contains multiple ports, which are the points of connection for network cables. These ports can be in an active state, where they are ready to transmit data, or in an idle state, where they consume less power.

Power consumption in datacenters has been a topic of concern due to the increasing demand for data processing and storage. One approach to reducing power consumption involves managing the power state of the switch ports. When a port is not in use, it can be put into a low-power idle mode, thereby saving energy. However, transitioning a port from idle mode to active mode can introduce latency, which is the delay before a transfer of data begins following an instruction for its transfer. Current policies that define when to transition a port between the active/idle modes of operation focus on making decisions for one type of traffic pattern or for one port at a time, and therefore cannot intelligently or dynamically adapt to a multitude of network parameters affecting traffic flows and/or multiple ports together.

There is thus a need for addressing these and/or other issues associated with the prior art. For example, there is a need to use artificial intelligence to transition ports between different modes of operation.

### SUMMARY

A method, computer readable medium, and system are disclosed to use artificial intelligence to transition ports between different modes of operation. A neural network processes state information observed for one or more ports of one or more switches connected to a network to determine a mode of operation for at least one port of the one or more ports. The at least one port is then caused to operate in the mode of operation.

### BRIEF DESCRIPTION OF THE DRAWINGS

FIG. 1 illustrates a flowchart of an inference-time method for using artificial intelligence to transition ports between different modes of operation, in accordance with an embodiment.

FIG. 2 illustrates a flowchart of an inference-time method for managing operation of a pair of connected ports, in accordance with an embodiment.

FIG. 3 illustrates a system for training an artificial intelligence model to transition ports between different modes of operation, in accordance with an embodiment.

FIG. 4 illustrates a network architecture, in accordance with an embodiment.

FIG. 5 illustrates an exemplary system, in accordance with an embodiment.

### DETAILED DESCRIPTION

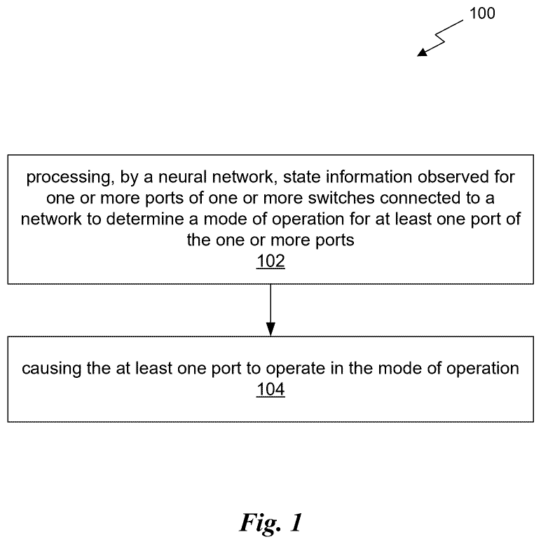

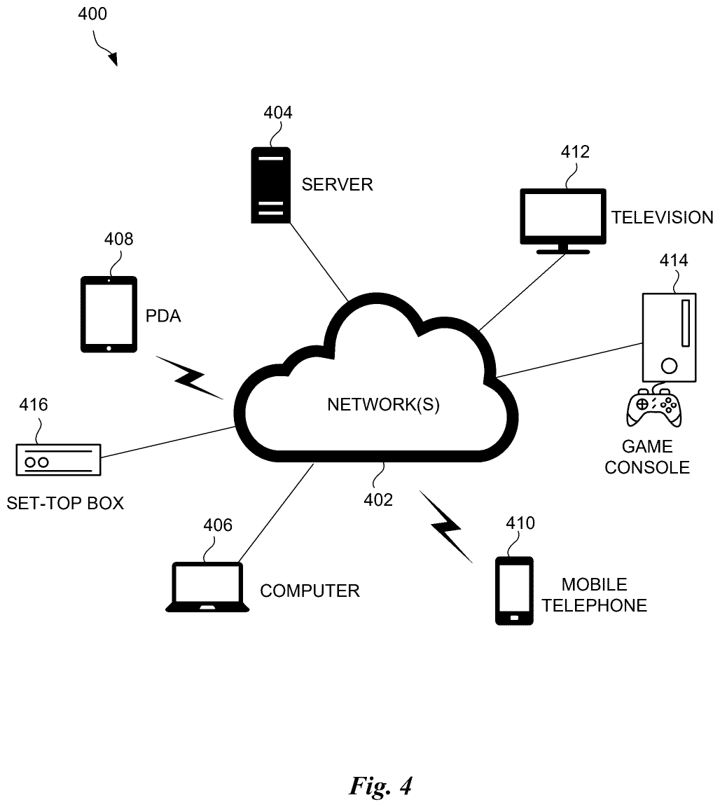

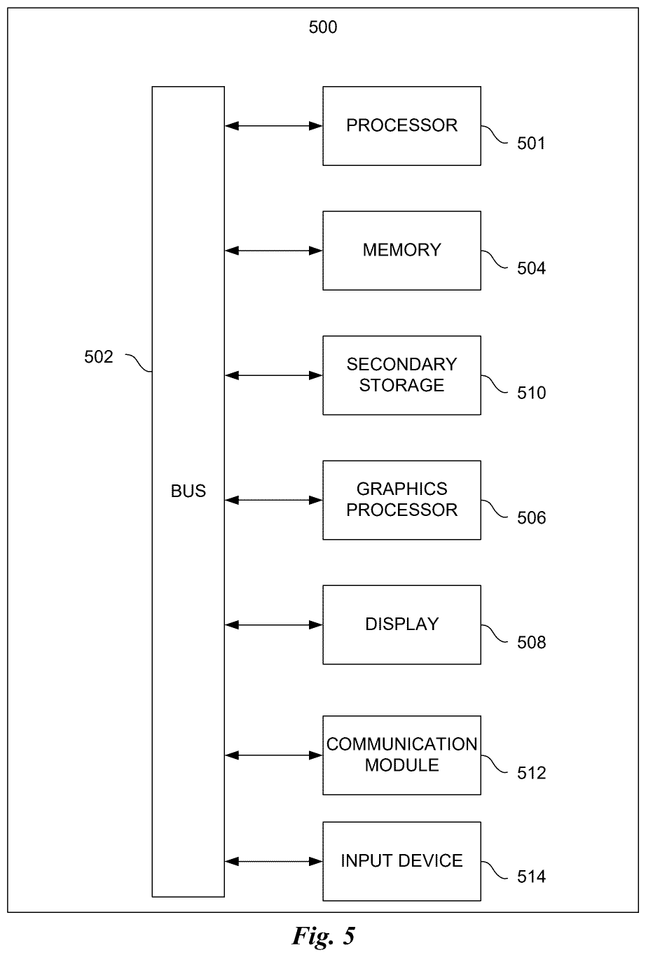

FIG. 1 illustrates a flowchart of an inference-time method 100 for using artificial intelligence to transition ports between different modes of operation, in accordance with an embodiment. The method 100 may be performed by a device, which may be comprised of a processing unit, a program, custom circuitry, or a combination thereof, in an embodiment. In another embodiment, a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100. As an example, the method 100 may be performed in the context of the devices in the network architecture 400 of FIG. 4 and/or in the context of the system 500 of FIG. 5.

In operation 102, a neural network processes state information observed for one or more ports of one or more switches connected to a network to determine a mode of operation for at least one port of the one or more ports. With respect to the present description, a switch refers to a physical device having at least one physical port that is capable of being physically connected (e.g. via a cable) to a physical port on another device (e.g. switch) to form a communication link between the two. The switch may therefore transmit and receive data over the communication link. In an embodiment, the switch may be a component of a datacenter.

The state information that is observed for the one or more ports refers to operating characteristics of the port(s). In embodiments, the state information may be bandwidth, utilization, queue size, a number of the delayed packets, and/or an average or maximum delay time among the delayed packets. In an embodiment, the state information may include a state of the port(s) including a mode in which the port(s) are operating (described in detail below). The state information may be observed over a defined period of time. The state information may be observed for a single port of a single switch connected to the network, for multiple ports of a single switch connected to the network, for a pair of connected ports respectively located on different switches connected to the network, or for two pairs of connected ports respectively located on different switches connected to the network, for example. In an embodiment, a connection may be established between the one or more ports for which the state information is observed, or in other words state information for two linked ports may be observed.

Each port for which the state information is observed is configured to be able to operate in at least two different modes of operation. The modes of operation may include an active mode, for example in which the port is capable of sending and/or transmitting data. The modes of operation may include an idle mode, in which the port is not capable of sending and/or transmitting data. In an embodiment, the active mode may consume more power than the idle mode, or in other words operating the port in the idle mode may cause the switch to consume less power than when operating the port in the active mode.

As mentioned above, a neural network processes the state information observed for the port(s) to determine (e.g. select) a mode of operation for at least one of the ports. In an embodiment, the mode of operation may be selected between at least a first mode of operation (e.g. the active mode) and a second mode of operation (e.g. the idle mode). In this way, the mode of operation for at least one of the ports may be intelligently determined using artificial intelligence, namely the neural network, as a function of the state information observed for the port(s).

The neural network refers to a machine learning model that has been trained to determine a mode of operation for a port as a function of the state information observed for at least that port. In an embodiment, the neural network may be trained on a remote datacenter. In an embodiment, the neural network may be trained using a network simulator. For example, the network simulator may simulate network activity, including port activity, to generate training data that can then be used to train the neural network.

In an embodiment, the neural network may be (e.g. continuously) trained using reinforcement learning. In an embodiment, the reinforcement learning may be configured to maximize a cumulative reward over time. For example, the cumulative reward may be computed from positive rewards given for saving power and negative rewards given for performance degradation. In this example, the power saving results from operating a port in an idle mode and is proportional to a time in which the port is operated in the idle mode. Also in this example, the performance degradation is defined as a delay in job completion time incurred due to packets being delayed when waiting to be sent through the port when operated in the idle mode.

In operation 104, the at least one port is caused to operate in the mode of operation. Specifically, the port is controlled to operate in the mode of operation determined by the neural network. In an embodiment, the port(s) may be caused to operate in the mode of operation by causing the at least one port to toggle between the first (e.g. active) mode of operation and the second (e.g. idle) mode of operation. For example, when a port is operating in a first mode but the neural network determines that the port is to operate in the second mode, then the mode of operation of the port may be toggled from the first mode to the second mode, and vice versa.

As mentioned above, the mode of operation may be determined for just one port in a pair of linked ports. Accordingly, in this case, the mode of operation of just one of the ports may be controlled per the determination made by the neural network. In another embodiment, the mode of operation may be determined for both linked ports, in which case the mode of operation of both linked ports may be controlled per the determination made by the neural network.

In an embodiment, after causing the port(s) to operate in the mode of operation determined by the neural network, one or more reward signals may be received. For example, the reward signal(s) may be received from the network a predefined amount of time following the initial operation of the port(s) in the mode of operation determined by the neural network. The one or more reward signals may be computed as a function of additional information observed for the one or more ports after causing the port(s) to operate in the mode of operation. For example, the reward signal(s) may be the positive and negative signals described above. The neural network may then be re-trained using the reward signal(s).

To this end, the method 100 may be performed to intelligently (i.e. using the neural network) and dynamically (e.g. based on the observed state information) transition a port or two linked ports between different modes of operation. For example, the neural network may rely on observations from multiple ports at the same time, to then cause the multiple ports to be activated or deactivated at the same time based on the joint observation. In an embodiment, the method 100 may be performed periodically. For example, the method 100 may be performed following a defined period of time in which the state information is observed for the port(s). As another example, the method 100 may be performed responsive to a predefined trigger detected in the network.

In an embodiment, the neural network may be dedicated for use in controlling operation of the one or more ports. For example, different instances of the neural network may be deployed for different ports or for different linked ports or for different switches. In this case, the neural network may be deployed remotely or locally with respect to a switch. As another example, the neural network may be generalized for use in controlling operation of a plurality of ports of a plurality of switches. In this case, the neural network may be deployed remotely with respect to the switches.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

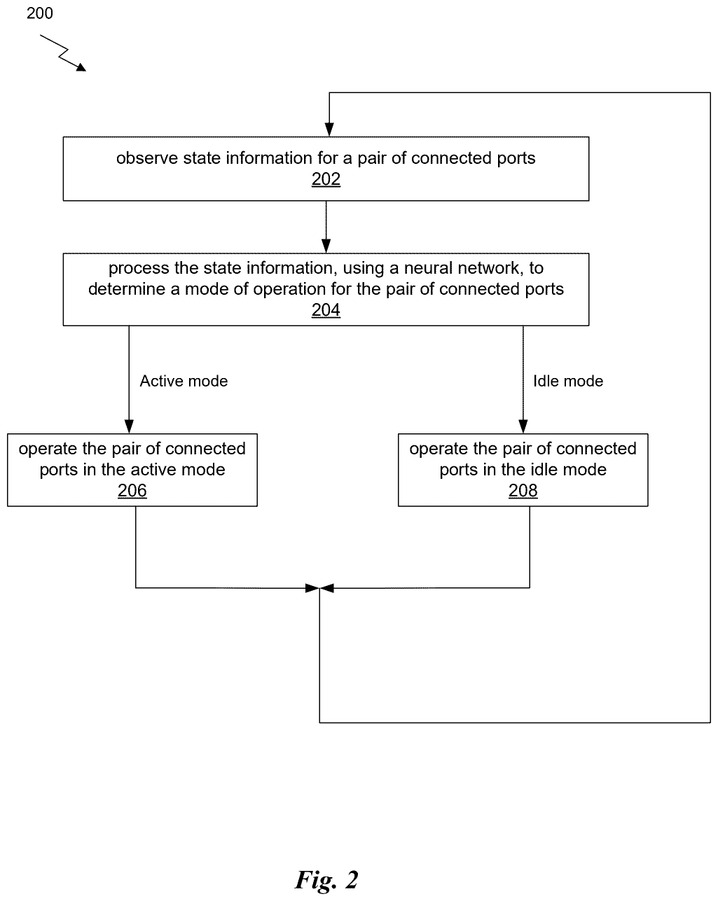

FIG. 2 illustrates a flowchart of an inference-time method 200 for managing operation of a pair of connected ports, in accordance with an embodiment. The method 200 describes a possible implementations of the method 100 of FIG. 1. The definitions and descriptions given above may therefore equally apply to the present embodiments.

In operation 202, state information for a pair of connected ports is observed. In an embodiment, the pair of connected ports may be operating in an active mode. In another embodiment, the pair of connected ports may be operating in an idle mode. The state information may be observed over a defined period of time. The state information may include bandwidth and/or utilization of each of the ports, in an embodiment. In an embodiment, the state information may include a number of the delayed packets transmitted and/or received by each of the ports and/or an average or maximum delay time among the delayed packets. In an embodiment, the state information may include a state of the port including a mode in which the port are operating (e.g. active or idle).

In operation 204, the state information is processed, using a neural network, determine a mode of operation for the pair of connected ports. In the present embodiment, the mode of operation is selected between an active mode of operation and an idle mode of operation.

When the neural network determines to operate the pair of connected ports in the active mode of operation, then in operation 206 the pair of connected ports are caused to be operated in the active mode. To this end, the pair of connected ports may communicate data with one another while operating in the active mode. When the neural network determines to operate the pair of connected ports in the idle mode of operation, then in operation 206 the pair of connected ports are caused to be operated in the idle mode. To this end, the pair of connected ports may be prevented from communicating data with one another while operating in the idle mode.

The method 200 then returns to operation 202. In particular, the method 100 repeats to observe additional state information for the pair of connected ports (operation 202) and to then use the neural network to determine a mode operation for the pair of connected ports based upon that additional state information (operation 204).

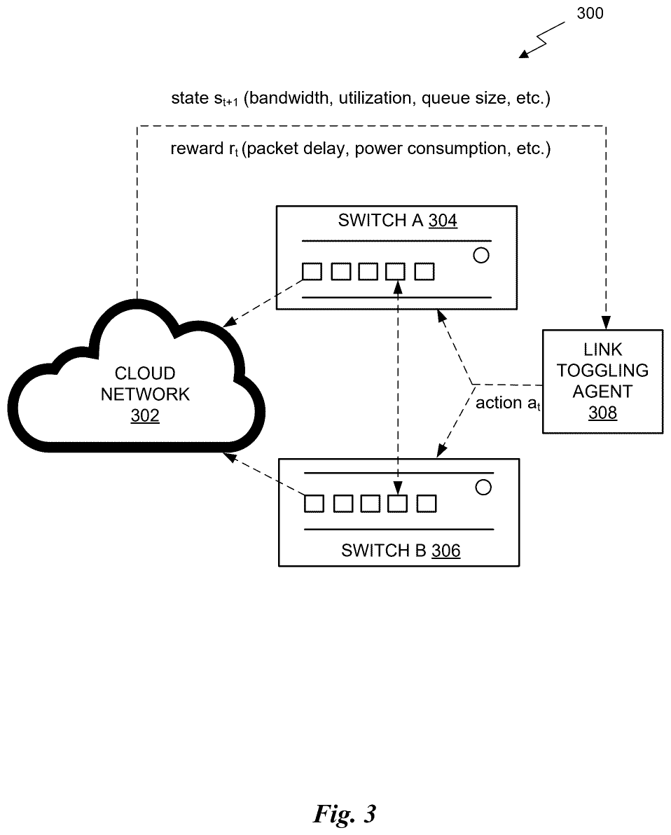

FIG. 3 illustrates a system 300 for training an artificial intelligence model to transition ports between different modes of operation, in accordance with an embodiment. The system 300 may be implemented in the context of the embodiments described above.

As shown, the system 300 includes a first switch 304 and a second switch 306 that each have a respective port connected to a network 302. Thus, the first switch 304 and the second switch 306 may be network connected to send and/or receive communications via the network 302. Another port of the first switch 304 is also connected to another port of the second switch 306 to allow direct communication therebetween (without using the network 302).

The system 300 further includes link toggling agent 308 that is configured to intelligently and dynamically toggle operation modes of the connected ports of the first switch 304 and the second switch 306. In an embodiment, the link toggling agent 308 may be deployed in the network 302. In an embodiment, the link toggling agent 308 may be deployed in a datacenter. In an embodiment, the link toggling agent 308 may be deployed in the first switch 304 or the second switch 306.

The link toggling agent 308 observes via the network 302, or otherwise accesses via the network 302, state information for the connected ports of the first switch 304 and the second switch 306. The link toggling agent 308 includes a neural network (not shown) that processes the state information to determine a mode of operation of the connected ports of the first switch 304 and the second switch 306. The link toggling agent 308 causes the first switch 304 and the second switch 306 to operate the connected ports in the mode determined by the neural network.

### Exemplary Implementation of the System 300

In a datacenter power consumption is significant and can become a bottleneck, limiting performance. To reduce power consumption by the data center, power consumption of the switches in the data center can be reduced by leveraging an idle mode of operation for ports of the switches. A reinforcement learning approach may be used to control agents 308 in a distributed manner across the network fabric over multiple switches (including switches 304, 306 as shown). Each agent 308 optimizes the power usage of the set of links connecting pairs of switches 304, 306 by controlling its idle mode toggling policy. The agents 308 make decisions based on state information observed in all network devices accessible to them.

In an embodiment, a reinforcement learning training environment runs an end-to-end network simulator. The network simulator models networking hardware at a micro architecture level and enables in-depth telemetry data collection. The environment is a wrapper for the network simulator, implementing a standard interface with the environment. Agents 308 include neural networks that are trained using the Proximal Policy Optimization (PPO) reinforcement learning algorithm. Agents 308 observe the switch state in the network simulator, containing features such as port bandwidth, buffer fill levels, etc. In return, the agents 308 use their neural network decide on toggling actions for the corresponding port. The environment also returns reward signals to the agent 308, which are a function of the agent action and environment state at a subsequent time step. Positive rewards are given for saving power (i.e. time spent in idle mode), while negative rewards are given for performance degradation (e.g. packets delayed due to port wake-up delay). The agent's 308 goal is to maximize the cumulative reward over time.

The neural network is trained using the PPO algorithm, which runs an Actor-Critic framework. The “critic” neural network evaluates the policy performance and is used in turn for improving the “actor” network, which constitutes the policy. The network simulator simulates a complete datacenter network including network interface cards (NICs), switches, links, etc. Since the aim is to achieve optimal results on real world popular traffic patterns, common large language model (LLM) training algorithms' network traces are modeled. The agents' 308 neural networks learn the intricate traffic characteristics of each network traffic type and develop a policy to both move links into the idle mode (i.e. low power state) and preemptively wake links up in preparation for traffic.

FIG. 4 illustrates a network architecture 400, in accordance with one possible embodiment. As shown, at least one network 402 is provided. In the context of the present network architecture 400, the network 402 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 402 may be provided.

Coupled to the network 402 is a plurality of devices. For example, a server computer 404 and an end user computer 406 may be coupled to the network 402 for communication purposes. Such end user computer 406 may include a desktop computer, lap-top computer, and/or any other type of logic. Still yet, various other devices may be coupled to the network 402 including a personal digital assistant (PDA) device 408, a mobile phone device 410, a television 412, a game console 414, a television set-top box 416, etc.

FIG. 5 illustrates an exemplary system 500, in accordance with one embodiment. As an option, the system 500 may be implemented in the context of any of the devices of the network architecture 400 of FIG. 4. Of course, the system 500 may be implemented in any desired environment.

As shown, a system 500 is provided including at least one central processor 501 which is connected to a communication bus 502. The system 500 also includes main memory 504 [e.g. random access memory (RAM), etc.]. The system 500 also includes a graphics processor 506 and a display 508.

The system 500 may also include a secondary storage 510. The secondary storage 510 includes, for example, a hard disk drive and/or a removable storage drive, representing a floppy disk drive, a magnetic tape drive, a compact disk drive, etc. The removable storage drive reads from and/or writes to a removable storage unit in a well-known manner.

Computer programs, or computer control logic algorithms, may be stored in the main memory 504, the secondary storage 510, and/or any other memory, for that matter. Such computer programs, when executed, enable the system 500 to perform various functions (as set forth above, for example). Memory 504, storage 510 and/or any other storage are possible examples of non-transitory computer-readable media.

The system 500 may also include one or more communication modules 512. The communication module 512 may be operable to facilitate communication between the system 500 and one or more networks, and/or with one or more devices through a variety of possible standard or proprietary communication protocols (e.g. via Bluetooth, Near Field Communication (NFC), Cellular communication, etc.).

As also shown, the system 500 may include one or more input devices 514. The input devices 514 may be wired or wireless input device. In various embodiments, each input device 514 may include a keyboard, touch pad, touch screen, game controller (e.g. to a game console), remote controller (e.g. to a set-top box or television), or any other device capable of being used by a user to provide input to the system 500.

As described herein, a method, computer readable medium, and system are disclosed to use artificial intelligence to transition ports between different modes of operation. In accordance with FIGS. 1-3, embodiments may provide a neural network, which may in turn be used to transition ports between different modes of operation. The methods may be implemented in the context of any of the devices depicted in FIGS. 4 and/or 5.

What is claimed is:

1. A method, comprising:
at a device:
processing, by a neural network, state information observed for one or more ports of one or more switches connected to a network to determine a mode of operation for at least one port of the one or more ports; and
causing the at least one port to operate in the mode of operation.

2. The method of claim 1, wherein the state information is observed for a single port of a single switch connected to the network.

3. The method of claim 1, wherein the state information is observed for multiple ports of a single switch connected to the network.

4. The method of claim 1, wherein the state information is observed for a connected pair of ports respectively located on different switches connected to the network.

5. The method of claim 1, wherein the state information is observed for two connected pairs of ports respectively located on different switches connected to the network.

6. The method of claim 1, wherein a connection is established between the one or more ports.

7. The method of claim 1, wherein the state information includes bandwidth.

8. The method of claim 1, wherein the state information includes utilization.

9. The method of claim 1, wherein the state information includes queue size.

10. The method of claim 1, wherein the state information includes information associated with delayed packets in the network, the information including at least one of:
a number of the delayed packets, or
an average or maximum delay time among the delayed packets.

11. The method of claim 1, wherein the mode of operation is selected between at least a first mode of operation and a second mode of operation.

12. The method of claim 11, wherein the first mode of operation includes an active mode and wherein the second mode of operation includes an idle mode.

13. The method of claim 12, wherein the active mode consumes more power than the idle mode.

14. The method of claim 1, wherein the neural network is trained using reinforcement learning.

15. The method of claim 14, wherein the reinforcement learning is configured to maximize a cumulative reward over time.

16. The method of claim 15, wherein the cumulative reward is computed from positive rewards given for saving power and negative rewards given for performance degradation, wherein the power saving results from operating a port in an idle mode, wherein the power saving is proportional to a time in which the port is operated in the idle mode, and wherein the performance degradation is defined as a delay in job completion time incurred due to packets being delayed when waiting to be sent through the port when operated in the idle mode.

17. The method of claim 1, wherein the neural network is trained using a network simulator.

18. The method of claim 1, wherein the neural network is trained on a remote datacenter.

19. The method of claim 1, wherein causing the at least one port to operate in the mode of operation includes:
causing the at least one port to toggle between a first mode of operation and a second mode of operation.

20. The method of claim 1, wherein the first mode of operation includes an active mode and wherein the second mode of operation includes an idle mode.

21. The method of claim 1, further comprising at the device:
receiving one or more reward signals, wherein the one or more reward signals are computed as a function of additional information observed for the one or more ports after causing the at least one port to operate in the mode of operation.

22. The method of claim 1, wherein the neural network is dedicated for use in controlling operation of the one or more ports.

23. The method of claim 1, wherein the neural network is generalized for use in controlling operation of a plurality of ports of a plurality of switches.

24. A system, comprising:
a non-transitory memory storage comprising instructions; and
one or more processors in communication with the memory, wherein the one or more processors execute the instructions to:
process, by a neural network, state information observed for one or more ports of one or more switches connected to a network to determine a mode of operation for at least one port of the one or more ports; and
cause the at least one port to operate in the mode of operation.

25. The system of claim 24, wherein the system is a component of a datacenter remote from the one or more switches.

26. The system of claim 24, wherein a connection is established between the one or more ports.

27. The system of claim 24, wherein the state information includes at least one of:
bandwidth,
utilization,
queue size,
a number of the delayed packets, or
an average or maximum delay time among the delayed packets.

28. The system of claim 24, wherein the mode of operation is selected between an active mode and an idle mode, wherein the active mode consumes more power than the idle mode.

29. The system of claim 24, wherein the neural network is trained using reinforcement learning, wherein the reinforcement learning is configured to maximize a cumulative reward over time.

30. The system of claim 29, wherein the cumulative reward is computed from positive rewards given for saving power and negative rewards given for performance degradation, wherein the power saving results from operating a port in an idle mode, wherein the power saving is proportional to a time in which the port is operated in the idle mode, and wherein the performance degradation is defined as a delay in job completion time incurred due to packets being delayed when waiting to be sent through the port when operated in the idle mode.

31. A non-transitory computer-readable media storing computer instructions which when executed by one or more processors of a device cause the device to:
process, by a neural network, state information observed for one or more ports of one or more switches connected to a network to determine a mode of operation for at least one port of the one or more ports; and
cause the at least one port to operate in the mode of operation.

32. The non-transitory computer-readable media of claim 31, wherein the system is a component of a datacenter remote from the one or more switches.

33. The non-transitory computer-readable media of claim 31, wherein a connection is established between the one or more ports.

34. The non-transitory computer-readable media of claim 31, wherein the state information includes at least one of:
bandwidth,
utilization,
queue size,
a number of the delayed packets, or
an average or maximum delay time among the delayed packets.

35. The non-transitory computer-readable media of claim 31, wherein the mode of operation is selected between an active mode and an idle mode, wherein the active mode consumes more power than the idle mode.

36. The non-transitory computer-readable media of claim 31, wherein the neural network is trained using reinforcement learning, wherein the reinforcement learning is configured to maximize a cumulative reward over time.

37. The non-transitory computer-readable media of claim 36, wherein the cumulative reward is computed from positive rewards given for saving power and negative rewards given for performance degradation, wherein the power saving results from operating a port in an idle mode, wherein the power saving is proportional to a time in which the port is operated in the idle mode, and wherein the performance degradation is defined as a delay in job completion time incurred due to packets being delayed when waiting to be sent through the port when operated in the idle mode.
